(19) United States
(12) Patent Application Publication
(10) Pub. No.: US 2008/0170084 A1
(43) Pub. Date: Jul. 17, 2008

(54) Information processing apparatus, information display method, and information display program product

(75) Inventors: Toshio Miyazawa, Kanagawa (JP); Tadashi Araki, Kanagawa (JP); Yuichi Kojima, Tokyo (JP); Yinghui Xu, Chiba (JP); Yoichiro Matsuno, Kanagawa (JP); Masaaki Kagawa, Tokyo (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/005,287

(22) Filed: Dec. 27, 2007

(30) Foreign Application Priority Data
Jan. 15, 2007 (JP) 2007-006352

(51) Int. Cl. G09G 5/00

(52) U.S. Cl. 345/660

(57) ABSTRACT

An information processing apparatus displays related information of information displayed in a region when the region is selected from regions displaying predetermined information and is displayed in an enlarged size, and does not display the related information when the selected region is displayed in a reduced size. The apparatus includes a selection unit for selecting the region to be either enlarged or reduced, a display unit for dynamically enlarging or reducing the region selected by the region selection unit, and a control unit for controlling an amount of the related information to be displayed based on an area of the region either enlarged or reduced by the display unit.

### CROSS REFERENCE TO RELATED APPLICATION

This application claims priority to Japanese patent application no. 2007-006352 filed on Jan. 15, 2007, the entire contents of which are hereby incorporated by reference herein.

### BACKGROUND OF THE INVENTION

1. Field of the Invention

The present invention relates to an information processing apparatus, an information display method, and an information display program product.

2. Discussion of the Background Arts

In recent years, along with the spread of such devices as a camera-equipped mobile phone and a digital video camera, documents handled in an office, such as a report, minutes of meeting, or notes, have been increasingly converted into a multimedia content constituted by a collection of objects in the form of a variety of media, such as a text, a still image, and a moving image.

As an example of a background technique for viewing such a multimedia content, there is a content browse system, a content server, a program, and a storage medium for displaying related information of a desired object when the object is selected and zoomed from the objects constituting the multimedia content displayed on a screen. The background technique, however, is for displaying the related information previously associated with a target object when the target object is zoomed in. Therefore, the background technique is not for changing the amount of the related information to be displayed in accordance with the area of a display region selected and specified by a user when the display region is zoomed.

### SUMMARY OF THE INVENTION

This patent specification describes an information processing apparatus. In one example, an information processing apparatus displays related information of information displayed in a region when the region is selected from regions displaying predetermined information and is displayed in an enlarged size, and does not display the related information when the selected region is displayed in a reduced size. The information processing apparatus includes a region selection unit, an enlarged and reduced display unit, and a related information amount control unit. The region selection unit selects the region to be displayed in either one of the enlarged size and the reduced size. The enlarged and reduced display unit dynamically displays the region selected by the region selection unit in either one of the enlarged size and the reduced size. The related information amount control unit controls the amount of the related information to be displayed, on the basis of the area of the region displayed in either one of the enlarged size and the reduced size by the enlarged and reduced display unit.

This patent specification further describes an information display method. In one example, an information display method displays related information of information displayed in a region when the region is selected from regions displaying predetermined information and is displayed in an enlarged size, and does not display the related information when the selected region is displayed in a reduced size. The information display method includes: selecting the region to be displayed in either one of the enlarged size and the reduced size; dynamically displaying the region selected in the selecting step in either one of the enlarged size and the reduced size; and controlling the amount of the related information to be displayed, on the basis of the area of the region displayed in either one of the enlarged size and the reduced size in the displaying step.

This patent specification further describes an information display program product. In one example, an information display program product displays related information of information displayed in a region when the region is selected from regions displaying predetermined information and is displayed in an enlarged size, and does not display the related information when the selected region is displayed in a reduced size. The information display program product includes a computer usable medium having computer readable program codes embodied in the medium that when executed causes a computer to execute: selecting the region to be displayed in either one of the enlarged size and the reduced size, dynamically displaying the region selected at the selecting in either one of the enlarged size and the reduced size, and controlling the amount of the related information to be displayed, on the basis of the area of the region displayed in either one of the enlarged size and the reduced size at the displaying.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a block diagram illustrating a hardware configuration of a computer according to an embodiment of the present invention;

FIG. 2 is a block diagram illustrating a functional configuration of the computer according to the embodiment of the present invention;

FIGS. 3A and 3B are flowchart illustrating an operation of the computer according to the embodiment of the present invention;

FIG. 4A is a diagram schematically illustrating a pattern example in which display information is created from original document information having a plurality of pages;

FIG. 4B is a diagram schematically illustrating a pattern example in which display information is created from original document information having one or a plurality of pages;

FIG. 5 is a diagram schematically illustrating an example of image-type display information displayed on the computer according to the embodiment of the present invention;

FIG. 6A is a front view illustrating an example of an initial screen displayed on the computer according to the embodiment of the present invention;

FIG. 6B is a front view illustrating an example of a screen displayed on the computer according to the embodiment of the present invention after a zoom-in operation;

FIGS. 7A to 7E are front views illustrating an example of transition of a part of the screen displayed on the computer according to the embodiment of the present invention in the zoom-in operation;

FIG. 8A is a front view illustrating an example of a search screen displayed on the computer according to the embodiment of the present invention;

FIG. 8B is a front view illustrating an example of the search screen displayed on the computer according to the embodiment of the present invention after a page turn;

FIG. 9A is a diagram schematically illustrating original document information having a plurality of pages, and sequential original document information created from the original document information;

FIG. 9B is a diagram illustrating a display example of the sequential original document information illustrated in FIG. 9A; and

FIG. 9C is a diagram illustrating a display example obtained after scrolling of the display illustrated in FIG. 9B.

### DETAILED DESCRIPTION OF THE INVENTION

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner.

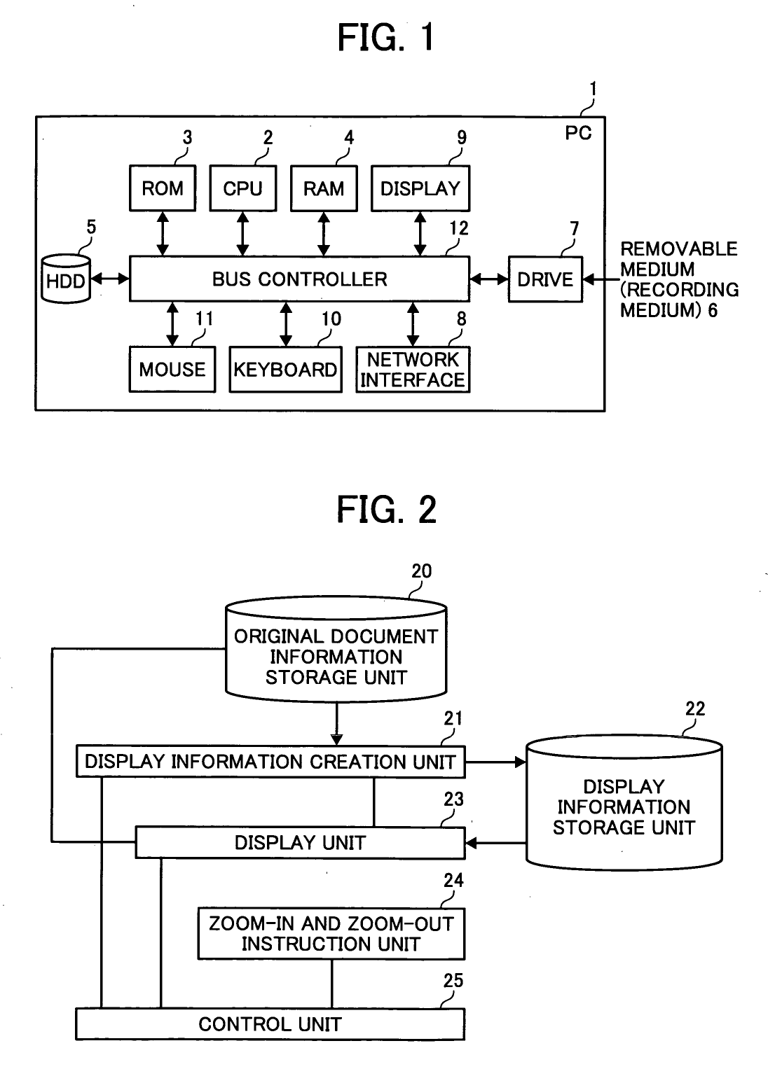

Referring now to the drawings, wherein like reference numerals designate identical or corresponding parts throughout the several views, particularly to FIG. 1, a personal computer according to an embodiment of the present invention will be described.

FIG. 1 is a configuration diagram illustrating the hardware of a general or standard personal computer 1 as an embodiment of the present invention. The personal computer (hereinafter referred to as the computer) 1 includes a CPU (Central Processing Unit) 2, a ROM (Read Only Memory) 3, a RAM (Random Access Memory) 4, a HDD (Hard Disk Drive) 5, a drive 7, a network interface 8, a display 9, a keyboard 10, and a mouse 11.

The CPU 2 performs information processing. The ROM 3 stores a BIOS (Basic Input Output System) and so forth. The RAM 4 temporarily stores information during a process. The HDD 5 constitutes a storage unit for storing an application program, a processing result, and so forth. The RAM 4 constitutes a first storage device, while the HDD 5 constitutes a second storage device. The drive 7 is a drive for a removable medium 6, which is a recording medium for having information stored in or distributed to an external device, or for obtaining information such as an application program from an external device. The network interface 8 connects the computer 1 to a network to communicate with an external computer. The display 9 constitutes a display unit for displaying such information as a processing status and a processing result to a user. The keyboard 10 and the mouse 11 constitute an input unit through which an operator inputs a command, information, and so forth to the computer 1. Data communication among the above members operates mediated by a bus controller 12.

As the removable medium 6, a variety of recording media can be employed. The variety of recording media includes, for example, a magnetic recording medium such as a flexible disk, a hard disk, and a magnetic tape, a magneto-optical recording medium such as an MO (Magneto-Optical Disk), an optical recording medium such as a CD (Compact Disk), a CD-ROM (Compact Disk-Read Only Memory), a CD-R (Compact Disk-Recordable), a CD-RW (Compact Disk-Rewritable), a DVD-ROM (Digital Versatile Disk-Read Only Memory), a DVD-R (Digital Versatile Disk-Recordable), a DVD-RAM (Digital Versatile Disk-Random Access Memory), a DVD-RW (Digital Versatile Disk-Rewritable), and a DVD+RW (Digital Versatile Disk+Rewritable), and a semiconductor memory.

In data transmission, data is transmitted to the network interface 8 of the computer 1, and the network interface 8 outputs a signal to the network. As for a signal received by the network interface 8, the network interface 8 determines whether or not the signal is necessary. Then, the network interface 8 performs a process of loading necessary data and discarding unnecessary data. That is, transmission and reception of all data are always performed through the network interface 8.

Generally, in the computer 1 configured as described above, when a user turns on the power supply of the computer 1, the CPU 2 runs a program called a loader, which is stored in the BIOS of the ROM 3. Then, the CPU 2 reads from the HDD 5 a program called an OS (Operating System), which manages the hardware and the software of the computer 1, and stores the program in the RAM 4. Upon start-up, the OS supports such operations as the start-up of an application program and the reading and storing of information in accordance with an operation by the user. A program running on the OS is called the application program. The application program is not limited to the program operating on a predetermined OS, but may be a program which causes the OS to perform a part of a variety of processes described later. Further, the application program may be included as a part of a group of program files constituting predetermined application software and OS.

The computer 1 stores in the HDD 5 a multimedia content browse program, i.e., an information display program according to an embodiment of the present invention, as the application program. In this sense, the HDD 5 functions as a recording medium for storing the multimedia content browse program.

Generally, the application program to be installed in the HDD 5 of the computer 1 is first recorded on the removable medium 6. Then, the application program recorded on the removable medium 6 is installed in the HDD 5. Thus, the removal medium 6 may also function as a recording medium for storing the multimedia content browse program. Alternatively, the multimedia content browse program may be externally loaded through the network interface 8 and installed in the HDD 5, for example.

In the computer 1, upon start-up of the multimedia content browse program operating on the OS, the CPU 2 performs a variety of arithmetic processes in accordance with the multimedia content browse program to intensively control the respective components of the computer 1. Among the variety of arithmetic processes performed by the CPU 2 of the computer 1, a multimedia content browse process, which is a process characterizing the present embodiment, will now be described. Schematically, according to the multimedia content browse process of the present embodiment, when a predetermined frame on a text-only initial screen is zoomed in with the use of a zooming metaphor, for example, more detailed-text information, a photo of participants in a meeting, and a moving image with sound of a discussion scene can be viewed, for example.

FIG. 2 is a block diagram illustrating a functional configuration of the computer 1. As the computer 1 and the CPU 2 follow the multimedia content browse program operating on the OS, an original document information storage unit 20, a display information creation unit 21, a display information storage unit 22, a display unit 23, a zoom-in and zoom-out instruction unit 24, and a control unit 25 are realized on the computer 1.

The original document information storage unit 20, which is a unit for storing original document information, is formed in the HDD 5, for example. The original document information herein refers to a multimedia content constituted by at least one type of object, e.g., text data or image data created by such applications as document creation software, graphic drawing software, and spreadsheet software, or scanned by such devices as a hand scanner and a digital camera. An original document information set stored in the original document information storage unit 20 may be either information having a single page or information having a plurality of pages.

The display information creation unit 21 is a unit for creating predetermined display information on the basis of an instruction sent from the control unit 25. The display information herein refers to related information which is created on the basis of predetermined original document information stored in the original document information storage unit 20, and which represents a content relating to the original document information, such as the summary of the original document information and the excerpt of a part of the original document information. The display information may be either image information (hereinafter referred to as the image-type display information) or text information (hereinafter referred to as the text-type display information). As the display information, at least one of the image-type display information and the text-type display information is created for each original document information set. The display of the created display information will be later described.

The display information storage unit 22 is a unit for storing the display information created by the display information creation unit 21. The display information is stored in association with the original document information from which the display information has been created. In the present example, the display information storage unit 22 stores the display information created by the display information creation unit 21. Alternatively, display information previously created by an external device other than the computer 1 may be stored in the display information storage unit 22 through an external interface and so forth.

The display unit 23 is a unit for controlling the display of a variety of information on the display 9, such as a zoom-in or zoom-out process. Particularly, in the present embodiment, on the basis of an instruction sent from the control unit 25, the display unit 23 receives the display information created by the display-information creation unit 21 directly from the display information creation unit 21, and displays the received display information on the display 9. Further, the display unit 23 retrieves predetermined display information from the display information stored in the display information storage unit 22, and displays the retrieved display information on the display 9.

The zoom-in and zoom-out instruction unit 24 is a unit for instructing, via the control unit 25, the display unit 23 to perform a zoom-in (i.e., enlarged display) process and a zoom-out (i.e., reduced display) process of a variety of information displayed on the screen of the display 9, on the basis of an operation of the computer 1 by the user. For example, it is now assumed that the user performs an operation of zooming in or zooming out a page of the original document information displayed on the screen of the display 9, or an operation of selecting a predetermined region in a page of the original document information displayed on the screen of the display 9 and zooming in or zooming out the selected region, by using such devices as the mouse 11 and the keyboard 10. In this case, the zoom-in and zoom-out instruction unit 24 instructs, via the control unit 25, the display unit 23 to perform a predetermined process. The zooming (i.e., zooming-in or zooming-out) operation performed in the present example is similar to the zooming operation commonly performed by a conventional personal computer and so forth.

As described above, upon receipt of the zoom-in or zoom-out instruction from the zoom-in and zoom-out instruction unit 24, the control unit 25 instructs the display information creation unit 21 to create predetermined display information, and instructs the display unit 23 to perform a predetermined zoom-in or zoom-out process. Further, when the zoom-in or zoom-out process is performed, the control unit 25 controls the information amount of the display information on the basis of the area of the region displayed in an enlarged size or a reduced size. The operation of controlling the information amount will be later described.

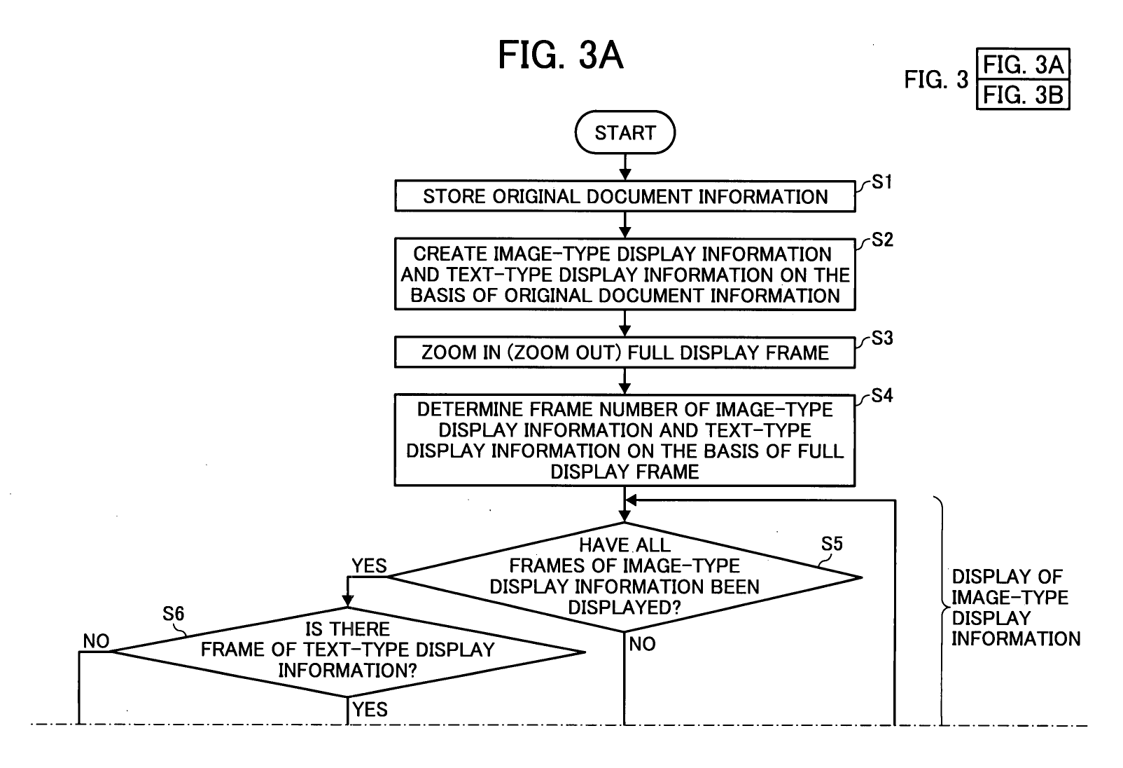

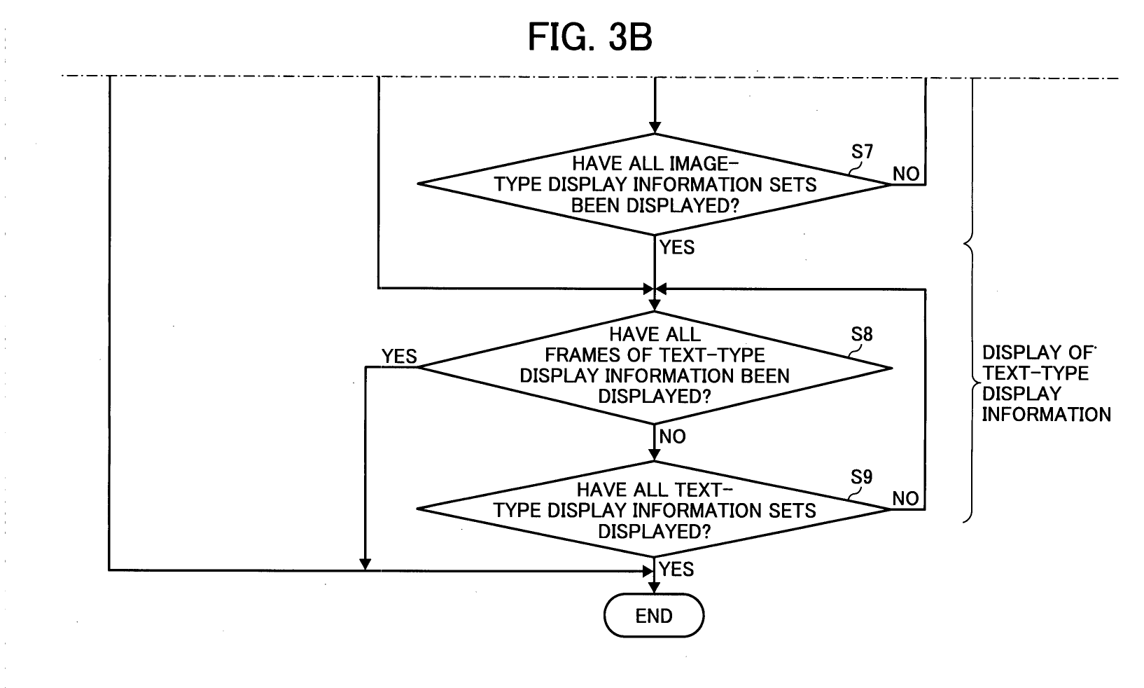

With reference to FIGS. 3A to 7E, detailed description will now be made of a multimedia content browse method, i.e., an information display method, which is performed by causing the computer 1 to execute the multimedia content browse program. In the following description, a specific embodiment will be described on the basis of the flow illustrated in FIGS. 3A and 3B, and with reference to other drawings when needed.

At Step S1 of FIG. 3A, predetermined original document information is stored in the original document information storage unit 20. Then, upon receipt of an instruction from the user for creating the display information of the original document information, the display information creation unit 21 performs a process of creating the display information at Step S2 of FIG. 3A.

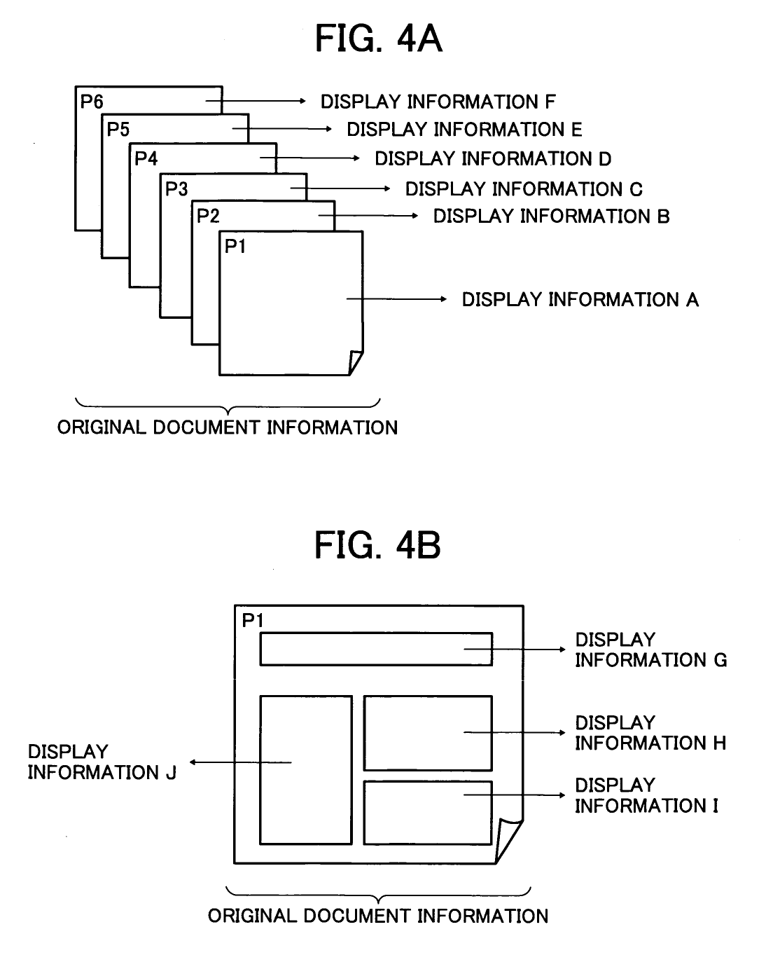

The process of creating the display information by the display information creation unit 21 will now be described with reference to FIG. 4. There are two patterns of creating the display information.

As illustrated in FIG. 4A, the first pattern can be applied to original document information having a plurality of pages. For example, if the original document information stored in the original document information storage unit 20 has six pages, the display information creation unit 21 creates display information A on the basis of the content of the first page P1 of the original document information, as illustrated in FIG. 4A.

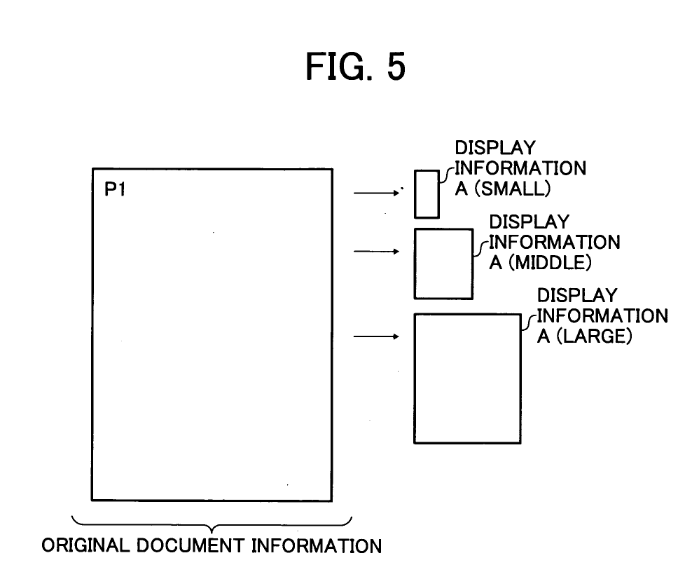

In the above, the display information A may be either the image-type display information or the text-type display information. The image-type display information includes, for example, a thumbnail image, i.e., a reduced image of the first page P1. In the creation of the thumbnail image, the display information creation unit 21 creates a plurality of thumbnail images of different sizes, e.g., a small size, a middle size, and a large size, as illustrated in FIG. 5, on the basis of the page size of the original document information. This is for enabling the displayed thumbnail image to be selected in accordance with the size of a display frame.

The text-type display information includes context information, such as the summary of the first page P1, the sentence of an initial part of the first page P1, and the name of the author of the page. Similarly to the first page P1, display information sets B to F are created for the second to sixth pages P2 to P6, respectively. The display information of the first to sixth pages P1 to P6 may be the same or different in the type (i.e., the image-type or the text-type) and the content (i.e., the summary or the sentence of the initial part) of the display information.

As illustrated in FIG. 4B, the second pattern can be applied to both original document information having a single page and original document information having a plurality of pages. For example, if the original document information stored in the original document information storage unit 20 has one page, the display information creation unit 21 creates respective display information sets G to J, as illustrated in FIG. 4B, on the basis of the content of the first page P1 of the original document information.

In the above process, the display information sets G to J are created on the basis of text elements extracted from the first page P1, such as a figure region, a photo region, and a title region, with the attributes of the respective regions of the first page P1 distinguished and separated from one another. In a method of the extraction, the original document information is converted into an image by a virtual printer driver, and the converted image is subjected to a region identification process used in a character image recognition process. Thereby, the image is separated into the text elements. On the basis of the separated text elements, each of the display information sets G to J is created as either the image-type display information or the text-type display information. That is, as the image-type display information, a plurality of thumbnail images of different sizes, e.g., the small size, the middle size, and the large size, are created on the basis of the original image size, such as the size of the figure or photo region, for example. Meanwhile, as the text-type display information, the context information, such as the summary of the region, the sentence of an initial part of the region, and the name of the author of the region, is created. Similarly to the above, plural sets of the display information are created for each page also in the case of the original document information having a plurality of pages.

If the original document information has a plurality of pages, the respective display information sets may be previously created in both of the above-described two patterns so that the user can select one of the patterns to display the display information.

The process of creating the display information by the display information creation unit 21 has been described above. The respective display information sets created for each original document information set in the above-described manner are stored in the display information storage unit 22.

Subsequently, description will be made of the processes of Step S3 and the subsequent steps of FIG. 3A performed when the user views the original document information stored in the display information storage unit 22. It is assumed in the following description that the original document information intended to be viewed by the user has six pages, and that the user has selected the display information created in the pattern illustrated in FIG. 4B to be displayed on each of the pages of the original document information. It is further assumed that the display information previously created in the pattern illustrated in FIG. 4B includes, for example, the display information G showing the title of a page (the text-type display information), the display information H showing a figure (the image-type display information), the display information I showing a photo (the image-type display information), and the display information J showing an explanatory text (the text-type display information), and that thumbnail images of a plurality of sizes have been created as the display information H and the display information I.

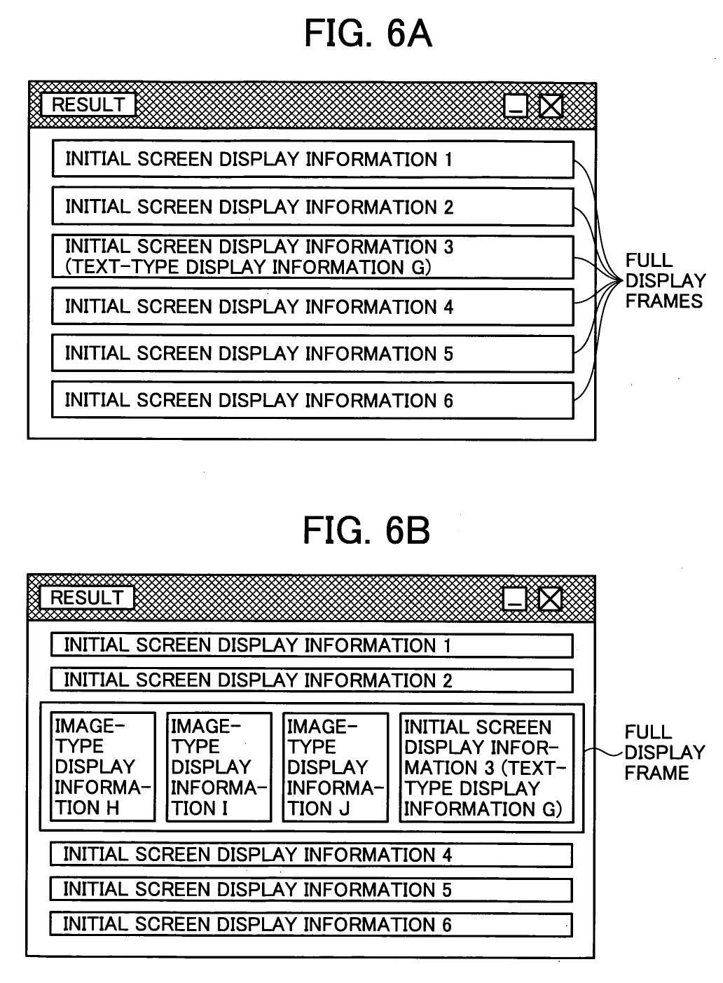

If the computer 1 is instructed to display the above-described original document information through an operation by the user, the control unit 25 instructs the display unit 23 to retrieve the target original document information requested by the user from the original document information storage unit 20 and to display the original document information. Thereby, the display 9 displays an initial screen illustrated in FIG. 6A. In the initial screen, initial screen display information sets 1 to 6 corresponding to the respective pages of the original document information are displayed in respective full display frames, as illustrated in FIG. 6A. In the present example, each of the initial screen display information sets 1 to 6 constitutes the display information G illustrated in FIG. 4B, for example. The display information G is the text-type display information showing the title of each of the pages. That is, in the initial screen of FIG. 6A, the respective full display frames display the respective titles of the first to sixth pages P1 to P6, i.e., the six pages of the original document information to be viewed.

In the present embodiment, the display information G of the text-type display information is used as the initial screen display information. However, the type (i.e., the image-type or the text-type) and the content (i.e., the summary or the sentence of the initial part) of the display information depend on the setting previously set. Further, although the display information G is used as the initial screen display information in the present embodiment, special information to be displayed on the initial screen may be previously created so that the initial screen displays the special information in place of the above-described display information.

Then, at Step S3 of FIG. 3A, when the user intends to view the third page P3 of the original document information, for example, the user instructs the full display frame displaying the initial screen display information 3 corresponding to the third page P3 to be zoomed in. On the initial screen illustrated in FIG. 6A, if the user performs an operation of moving a not-illustrated mouse pointer to a predetermined position on the full display frame displaying the initial screen display information 3 and dragging the frame in the downward direction of the screen with a left click button held down, for example, the zoom-in and zoom-out instruction unit 24 detects the operation and informs the control unit 25 of the operation. Then, the control unit 25 instructs the display unit 23 to perform a process of zooming in the selected full display frame. Accordingly, the zoom-in display, i.e., the enlarged display of the full display frame displaying the initial screen display information 3 is performed.

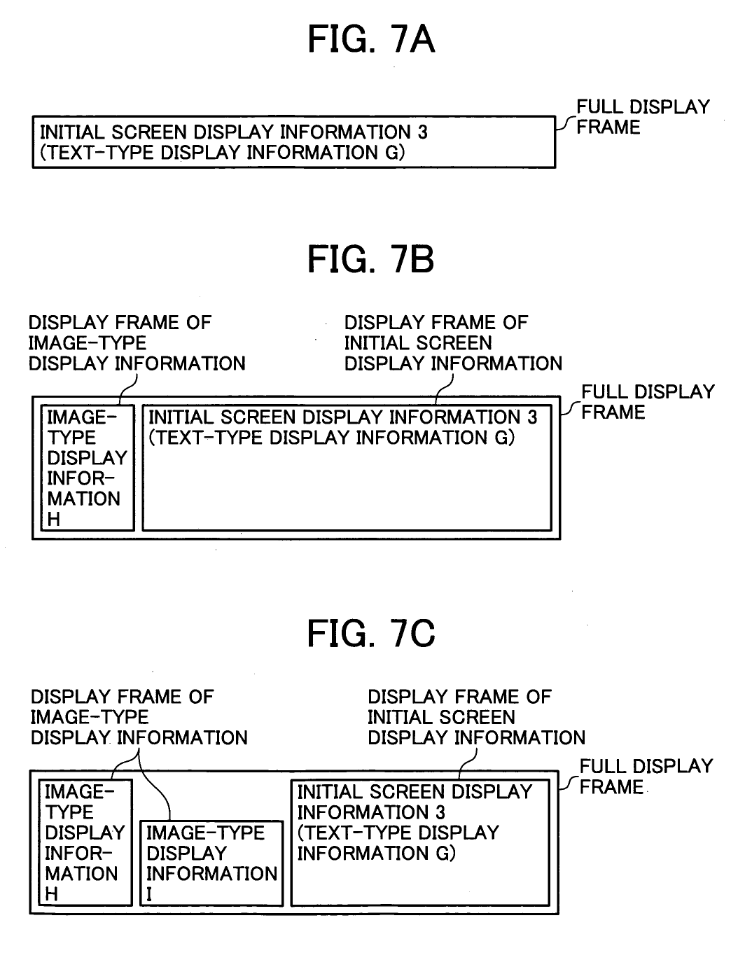

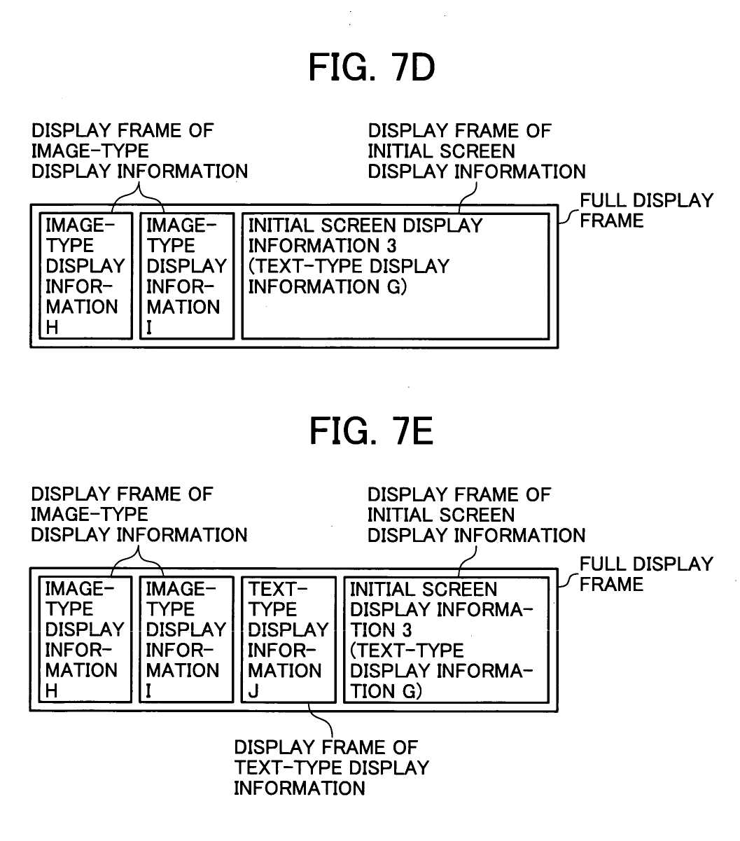

In the above process, if the full display frame illustrated in FIG. 7A is zoomed in to the size illustrated in FIG. 7B, for example, the control unit 25 determines at Step S4 of FIG. 3A the number of display frames of each of the image-type display information of the text-type display information of the original document information to be viewed, on the basis of the size of the enlarged full display frame. If the full display frame is of the size illustrated in FIG. 7B, the number of display frames of the image-type display information and the number of display frames of the text-type display information are assumed to be determined as one and zero, respectively. The number of display frames of the initial screen display information 3 (i.e., the text-type display information G) is assumed to have been previously secured as one. The full display frame illustrated in FIG. 7A also serves as the display frame of the initial screen display information illustrated in FIG. 7B.

Upon determination of the number of display frames of each display information, the control unit 25 controls the display unit 23 to retrieve predetermined display information from the display information storage unit 22 and display the retrieved display information. In the present example, the number of display frames of the text-type display information has been determined as zero. Thus, predetermined image-type display information is retrieved and displayed.

In this process, if there is image-type display information (e.g., a thumbnail image) of a size not exceeding the size of the display frame, the information is displayed in the display frame. Meanwhile, if there is no image-type display information of a suitable size, the display unit 23 informs the control unit 25 of the absence of such information. Then, the control unit 25 instructs the display information creation unit 21 to create a new thumbnail image of a size not exceeding the display frame, on the basis of a thumbnail image of the size closest to the size of the display frame out of the plurality of thumbnail images previously created as the image-type display information. Accordingly, as illustrated in FIG. 7B, the image-type display information H is displayed in the display frame.

In FIG. 7B, along with the display of the image-type display information H, the display frame of the initial screen display information 3 is newly generated separately from the full display frame. The display frame of the initial screen display information 3 illustrated in FIG. 7B is reduced in the horizontal width and increased in the vertical width, as compared with the full display frame of FIG. 7A, which also serves as the display frame of the initial screen display information 3. The displayed content of the initial screen display information 3 of FIG. 7B is unchanged from the displayed content of FIG. 7A, except for a change in the layout of the character string and the font size.

At Step S5 of FIG. 3A, the control unit 25 determines whether or not all of the display frames of the image-type display information have been displayed. In the above case, the number of display frames of the image-type display information has been determined as one. As illustrated in FIG. 7B, the image-type display information H (i.e., the display frame of the information) has been displayed in the full display frame. Thus, the control unit 25 determines that all of the display frames of the image-type display information, i.e., one display frame in the present example, have been displayed (YES at Step S5). Then, the control unit 25 determines whether or not there is any number of display frames of the text-type display information (Step S6). In the above case, the number of display frames of the text-type display information has been determined as zero. Thus, the control unit 25 determines that there is no text-type display information (NO at Step S6), and completes the sequence of processes. In this case, the other image-type display information I is not displayed in the display frame of FIG. 7B.

If the number of display frames of the text-type display information has been determined as a number other than zero, the control unit 25 determines at Step S6 that there is the text-type display information (YES at Step S6). Thus, the control unit 25 proceeds to the processes of Step S8 and the subsequent steps for displaying the text-type display information. The steps will be later described. Further, if the number of display frames of the image-type display information has been determined as zero at Step S4, the control unit 25 determines at Step S5 that all of the display frames of the image-type display information, i.e., no display frame in this case, have been displayed (YES at Step S5). Then, the control unit 25 proceeds to Step S6.

If the control unit 25 determines at Step 5S of FIG. 3A that all of the display frames of the image-type display information have not been displayed (NO at Step S5), i.e., if all of the display frames of the image-type display information H have not been displayed in the enlarged full display frame, for example, the control unit 25 determines whether or not all of the image-type display information sets of the original document information to be viewed have been displayed (Step S7). If all of the image-type display information sets, i.e., the image-type display information sets H and I in the present embodiment, have not been displayed (NO at Step S7), the procedure returns to Step S5. If all of the image-type display information sets have been displayed at Step S7 (YES at Step S7), i.e., if the determined number of display frames of the image-type display information is larger than the number of the previously created image-type display information sets, for example, the procedure proceeds to the processes of Step S8 and the subsequent steps for displaying the text-type display information. The steps will be later described.

Subsequently, description will be made of a case in which the full display frame illustrated in FIG. 7B is further zoomed in. If the full display frame illustrated in FIG. 7B is zoomed in to the size illustrated in FIG. 7C, for example (Step S3 of FIG. 3A), the control unit 25 determines at Step S4 of FIG. 3A the number of display frames of each of the image-type display information and the text-type display information of the original document information to be viewed, on the basis of the size of the enlarged full display frame. If the full display frame is of the size illustrated in FIG. 7C, the number of display frames of the image-type display information and the number of display frames of the text-type display information are assumed to be determined as two and zero, respectively. The number of display frames of the initial screen display information 3 (i.e., the text-type display information G) is assumed to have been previously secured as one.

At Step S5 of FIG. 3A, the control unit 25 determines whether or not all of the display frames of the image-type display information have been displayed. In the above case, the number of display frames of the image-type display information has been determined as two. As illustrated in FIG. 7C, the image-type display information H and the image-type display information I (i.e., the display frames of the information sets) have been displayed in the full display frame. Thus, the control unit 25 determines that all of the display frames of the image-type display information, i.e., two display frames in the present example, have been displayed (YES at Step S5). Then, the control unit 25 determines whether or not there is any number of display frames of the text-type display information (Step S6). In the above case, the number of display frames of the text-type display information has been determined as zero. Thus, the control unit 25 determines that there is no text-type display information (NO at Step S6), and completes the sequence of processes. FIG. 7C illustrates a case in which the image-type display information H is displayed in the form of a thumbnail image of the largest size and the image-type display information I is displayed in the form of a thumbnail image of the smallest size.

Subsequently, description will be made of a case in which the full display frame illustrated in FIG. 7C is further zoomed in. If the full display frame illustrated in FIG. 7C is zoomed in to the size illustrated in FIG. 7D, for example (Step S3 of FIG. 3A), the control unit 25 determines at Step S4 of FIG. 3A the number of display frames of each of the image-type display information and the text-type display information of the original document information to be viewed, on the basis of the size of the enlarged full display frame. If the full display frame is of the size illustrated in FIG. 7D, the number of display frames of the image-type display information and the number of display frames of the text-type display information are assumed to be determined as two and zero, respectively. The number of display frames of the initial screen display information 3 (i.e., the text-type display information G) is assumed to have been previously secured as one.

At Step S5 of FIG. 3A, the control unit 25 determines whether or not all of the display frames of the image-type display information have been displayed. In the above case, the number of display frames of the image-type display information has been determined as two. As illustrated in FIG. 7D, the image-type display information H and the image-type display information I (i.e., the display frames of the information sets) have been displayed in the full display frame. Thus, the control unit 25 determines that all of the display frames of the image-type display information, i.e., two display frames in the present example, have been displayed (YES at Step S5). Then, the control unit 25 determines whether or not there is any number of display frames of the text-type display information (Step S6). In the above case, the number of display frames of the text-type display information has been determined as zero. Thus, the control unit 25 determines that there is no text-type display information (NO at Step S6), and completes the sequence of processes. FIG. 7D illustrates a case in which each of the image-type display information H and the image-type display information I is displayed in the form of a thumbnail image of the largest size.

Subsequently, description will be made of a case in which the full display frame illustrated in FIG. 7D is further zoomed in. If the full display frame illustrated in FIG. 7D is zoomed in to the size illustrated in FIG. 7E, for example (Step S3 of FIG. 3A), the control unit 25 determines at Step S4 of FIG. 3A the number of display frames of each of the image-type display information and the text-type display information of the original document information to be viewed, on the basis of the size of the enlarged full display frame. If the full display frame is of the size illustrated in FIG. 7E, the number of display frames of the image-type display information and the number of display frames of the text-type display information are assumed to be determined as two and one, respectively. The number of display frames of the initial screen display information 3 (i.e., the text-type display information G) is assumed to have been previously secured as one.

At Step S5 of FIG. 3A, the control unit 25 determines whether or not all of the display frames of the image-type display information have been displayed. In the above case, the number of display frames of the image-type display information has been determined as two. As illustrated in FIG. 7E, the image-type display information H and the image-type display information I (i.e., the display frames of the information sets) have been displayed in the full display frame. Thus, the control unit 25 determines that all of the display frames of the image-type display information, i.e., two display frames in the present example, have been displayed (YES at Step S5). Then, the control unit 25 determines whether or not there is any number of display frames of the text-type display information (Step S6). In the above case, the number of display frames of the text-type display information has been determined as one. Thus, the control unit 25 determines that there is the text-type display information (YES at Step S6), and proceeds to Step S8.

At Step S8 of FIG. 3B, the control unit 25 determines whether or not all of the display frames of the text-type display information have been displayed. In the above case, the number of display frames of the text-type display information has been determined as one. As illustrated in FIG. 7E, the text-type display information J (i.e., the display frame of the information) has been displayed in the full display frame. Thus, the control unit 25 determines that all of the display frames of the text-type display information, i.e., one display frame in the present example, have been displayed (YES at Step S8), and completes the sequence of processes.

If the control unit 25 determines at Step S8 of FIG. 3B that all of the display frames of the text-type display information have not been displayed (NO at Step S8), i.e., if all of the display frames of the text-type display information J have not been displayed in the enlarged full display frame, for example, the control unit 25 determines whether or not all of the text-type display information sets of the original document information to be viewed have been displayed (Step S9). If all of the text-type display information sets, i.e., the text-type display information J in the present embodiment, have not been displayed (NO at Step S9), the procedure returns to Step S8. If all of the text-type display information sets have been displayed at Step S9 (YES at Step S9), i.e., if the determined number of display frames of the text-type display information is larger than the number of the previously created text-type display information sets, for example, the sequence of processes is completed. FIG. 7E illustrates a case in which each of the image-type display information H, the image-type display information I, and the text-type display information J is displayed in the form of a thumbnail image of the largest size.

As described above, in the final display of the image-type display information H, the image-type display information I, and the text-type display information J, for example, the display as illustrated in FIG. 6B appears on the screen of the display 9. In this case, as illustrated in FIG. 6B, along with the enlarged display of the full display frame of the initial screen display information 3, the full display frames of the initial screen display information sets 1, 2, 4, 5, and 6 are displayed in a reduced size.

In the above description of the present embodiment, the number of the image-type display information sets is two, and the number of the text-type display information sets is one. Each of the numbers, however, is not limited to the above. Further, only one of the image-type display information and the text-type display information may be used.

Further, in the above description of the present embodiment, the zoom-in operation is performed in a stepwise manner from FIG. 7A to FIG. 7E. However, it is also possible to directly zoom in from FIG. 7A to FIG. 7E, and to zoom in from FIG. 7A to FIG. 7B and then to FIG. 7D, for example.

Further, in the above description of the present embodiment, the zoom-in operation is performed at Step S3 of FIG. 3A. However, a similar process is performed also in the zoom-out operation. That is, the number of display frames of each display information is determined on the basis of the reduced full display frame. Then, on the basis of the determined number of the display frames, predetermined display information is displayed in the full display frame, with or without size adjustment process performed on the display information. It is therefore possible to zoom out from FIG. 7E to FIG. 7A in a stepwise manner, and to zoom out from FIG. 7E to FIG. 7D and then to FIG. 7B.

Further, in the above description of the present embodiment, the full display frame is zoomed. Alternatively, the display frame of the image-type display information or the text-type display information may be specified and zoomed to further display the display information relating to the display information. For example, it may be configured such that, if the display frame of the image-type display information H is zoomed in in FIG. 7E, the display information of the image-type display information H, which is information of either the image-type or the text-type previously created and stored similarly as described above, is displayed in the full display frame or in the display frame of the image-type display information H.

As described above, according to the present embodiment, the number of display frames of the display information is determined on the basis of the size of the full display frame specified by the user, and predetermined display information is displayed on the basis of the determined number of display frames. Therefore, if the display region, i.e., the above-described full display frame selected and specified by the user is zoomed, the amount of the information to be displayed can be changed in accordance with the area of the display region. That is, the user can adjust the amount of the information by changing the zooming of a predetermined region.

Further, according to the present embodiment, a plurality of thumbnail images of different sizes have been previously created for each display information set. Then, when the size of the full display frame is specified through the zooming operation, a thumbnail image of a predetermined size is selected and displayed from the plurality of thumbnail images. Thus, the present embodiment is capable of flexibly responding to the change in size of the full display frame and performing high-speed processing. Furthermore, when the size of the full display frame is specified by the zooming operation, a new thumbnail image is created and displayed on the basis of a thumbnail image of a predetermined size among the plurality of thumbnail images. Thus, the present embodiment is capable of further flexibly responding to the change in size of the full display frame and performing high-speed processing.

Lastly, supplemental description will be made of the above-described embodiment. With specific examples, description will be made of a method of retrieving the original document information to be viewed, which is performed by the user in the above-described embodiment as a preparatory step before the zooming operation.

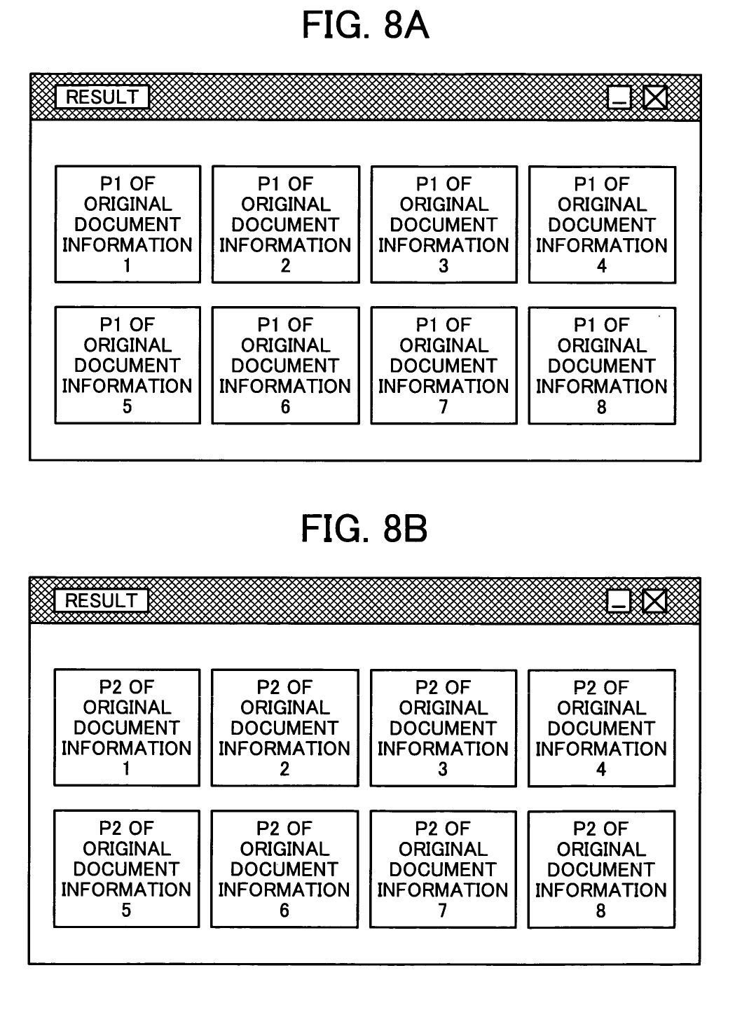

In the first example, as illustrated in FIG. 8A, if the control unit 25 receives an instruction operation by the user before the initial screen illustrated in FIG. 6A is displayed, the control unit 25 instructs the display unit 23 to display, on the same screen, a predetermined page, e.g., the first page P1 in the drawing, of plural sets of the original document information stored in the original document information storage unit 20. Then, when the user performs a predetermined page-turning operation through an operation using the mouse and so forth, the display of the page of the respective original document information sets is simultaneously changed to another predetermined page, e.g., the second page P2 in the drawing. Then, after the page-turning operation, the user selects a desired page of a desired original document information set through a predetermined operation. Thereby, the display is switched to the initial screen illustrated in FIG. 6A.

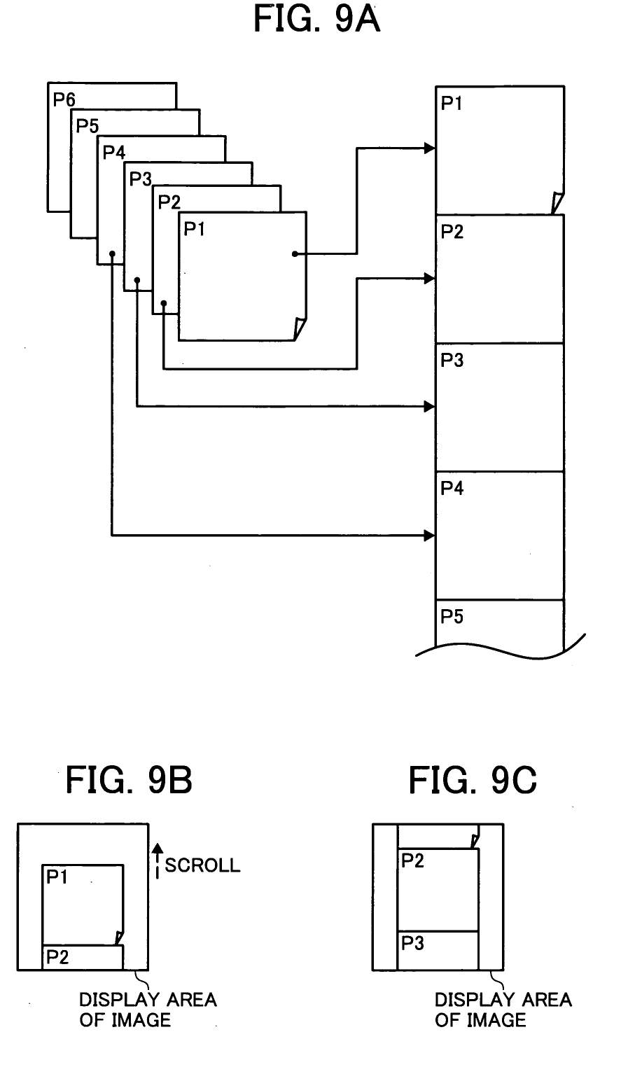

In the second example, if original document information having a plurality of pages as illustrated in the left side of FIG. 9A is stored in the original document information storage unit 20, upon receipt of an instruction operation by the user, the control unit 25 instructs the display information creation unit 21 to create sequential original document information by sequentially connecting the respective pages of the original document information, as illustrated in the right side of FIG. 9A. The thus created sequential original document information is stored in the display information storage unit 22. Then, if the control unit 25 receives an instruction operation by the user before the initial screen illustrated in FIG. 6A is displayed, the control unit 25 instructs the display unit 23 to display the sequential original document information in a predetermined display region on the screen of the display 9, as illustrated in FIG. 9B. In FIG. 9B, which mainly displays the first page P1, if the user performs a scrolling operation in the upward direction of the screen, for example, the second page P2 connected to a lower part of the first page P1 is displayed, as illustrated in FIG. 9C. Needless to day, if the scrolling operation is performed in the downward direction in FIG. 9C, the display returns to the display illustrated in FIG. 9B. Then, after the scrolling operation, the user selects a desired page through a predetermined operation, and the display is switched to the initial screen illustrated in FIG. 6A. The present example is configured such that the respective pages are connected in the vertical direction. However, the configuration is not limited to the above.

In the third example, if a predetermined image relating to desired original document information is input with the use of an image scanning device, such as a scanner, the control unit 25 instructs the display unit 23 to retrieve, on the basis of the input image, original document information including an image similar to the input image from the original document information storage unit 20, and to display the result of the retrieval on the display 9. If plural sets of the original document information have been retrieved as a result of the retrieval, for example, the plural sets of the original document information are displayed on the screen, as illustrated in FIG. 8A, for example. Then, the user selects a desired original document information set through a predetermined operation, and the display is switched to the initial screen illustrated in FIG. 6A. In the present example, the user selects the desired original document information set after the display of the retrieval result. However, the original document information set does not necessarily need to be selected by the user.

The present invention can be applied to devices and equipment in general capable of displaying predetermined information to a user.

An embodiment of the present invention and examples of the embodiment have been described above. The above-described embodiment is illustrative and does not limit the present invention. Thus, numerous additional modifications and variations are possible in light of the above teachings. For example, elements and/or features of different illustrative and exemplary embodiments herein may be combined with each other and/or substituted for each other within the scope of this disclosure and appended claims.

Further, features of components of the embodiment, such as the number, the position., and the shape, are not limited to the embodiment and thus may be preferably set. It is therefore to be understood that within the scope of the appended claims, the disclosure of this patent specification may be practiced otherwise than as specifically described herein.

1. An information processing apparatus for displaying related information of information displayed in a region, the information processing apparatus comprising:
a selection unit for selecting the region to be either enlarged or reduced;
a display unit for dynamically enlarging or reducing the region selected by the selection unit; and
a control unit for controlling an amount of the related information to be displayed based on an area of the region either enlarged or reduced by the display unit.

2. The information processing apparatus as described in claim 1,
wherein the related information comprises either one of information representing a part of the information displayed in the selected region or information created based on the information displayed in the selected region.

3. The information processing apparatus as described in claim 1,
wherein multiple sets of the related information of identical content and different sizes are previously created, and
wherein, based on the area of the region either enlarged or reduced by the display unit, the control unit performs at least one of a first process and a second process,
the first process comprising selecting a set of the related information of a size not exceeding the area of the region from the previously created multiple sets of the related information, and displaying the selected set of the related information,
the second process comprising selecting a set of the related information from the previously created multiple sets of the related information, processing the selected set of the related information into a size not exceeding the area of the region, and displaying the selected and processed set of the related information.

4. The information processing apparatus as described in claim 1,
wherein, when the related information is displayed and selected, the display unit further displays related information of the related information.

5. An information display method for displaying related information of information displayed in a region, the information display method comprising;
a selection step of selecting the region to be either enlarged or reduced;
a display step of dynamically enlarging or reducing the region selected in the selecting step; and
a control step of controlling an amount of the related information to be displayed based on an area of the region enlarged or reduced in the display step.

6. The information display method as described in claim 5,
wherein the related information comprises either one of information representing a part of the information displayed in the selected region or information created based on the information displayed in the selected region.

7. The information display method as described in claim 5,
wherein multiple sets of the related information of identical content and different sizes are previously created, and
wherein, based on the area of the region either enlarged or reduced in the display step, the control step comprises at least one of a first process and a second process,
the first process comprising selecting a set of the related information of a size not exceeding the area of the region from the previously created multiple sets of the related information, and displaying the selected set of the related information,
the second process comprising selecting a set of the related information from the previously created multiple sets of the related information, processing the selected set of the related information into a size not exceeding the area of the region, and displaying the selected and processed set of the related information.

8. The information display method as described in claim 5,
wherein, when the related information is displayed and selected, the display step further displays related information of the related information.

9. An information display program product for displaying related information of information displayed in a region, the information display program product comprising:
a computer usable medium having computer readable program codes embodied in the medium that when executed cause a computer to execute an information display method comprising:
selecting the region to be either enlarged or reduced;
dynamically enlarging or reducing the region selected; and
controlling an amount of the related information to be displayed based on an area of the region enlarged or reduced.

10. The information display program product as described in claim 9,
wherein the related information comprises either one of information representing a part of the information displayed in the selected region or information created based on the information displayed in the selected region.

11. The information display program product as described in claim 9,
wherein multiple sets of the related information of identical content and different sizes are previously created, and
wherein, based on the area of the region displayed in either one of the enlarged size and the reduced size at the displaying, the controlling comprises at least one of a first process and a second process,
the first process comprising selecting a set of the related information of a size not exceeding the area of the region from the previously created multiple sets of the related information, and displaying the selected set of the related information,
the second process comprising selecting a set of the related information from the previously created multiple sets of the related information, processing the selected set of the related information into a size not exceeding the area of the region, and displaying the selected and processed set of the related information.

12. The information display program product as described in claim 9,
wherein, when the related information is displayed and selected, the displaying further displays related information of the related information.
